(19) United States
(12) Patent Application Publication
(10) Pub. No.: US 2017/0094322 A1
(43) Pub. Date: Mar. 30, 2017

(54) SYSTEM AND CORRESPONDING METHOD FOR FACILITATING APPLICATION OF A DIGITAL VIDEO-EFFECT TO A TEMPORAL PORTION OF A VIDEO SEGMENT

(71) Applicant: Tribune Broadcasting Company, LLC, Chicago, IL (US)

(72) Inventors: Scott Allan PROPST, Noblesville, IN (US); Dana A. LASHER, Morgan Hill, CA (US)

(21) Appl. No.: 14/864,646

(22) Filed: Sep. 24, 2015

(51) Int. Cl. H04N 21/234; G11B 27/031; H04N 21/262; H04N 21/2343; H04N 21/845; G11B 27/10; H04N 21/458

(52) U.S. Cl. CPC H04N 21/23424; G11B 27/10; G11B 27/031; H04N 21/458; H04N 21/234345; H04N 21/8456; H04N 21/262

(57) ABSTRACT

In one aspect, an example method includes: receiving an instruction to apply a first particular DVE to a temporal portion of a video segment; making a determination that no temporal portion of the video segment satisfies each condition in a condition set; and based, at least in part, on the received instruction and the determination, transmitting to a DVE system a first instruction that causes the DVE system to apply a second particular DVE to a particular temporal portion of the video segment, thereby causing first content within a region of the particular temporal portion of the video segment to be removed, and a second instruction that causes the DVE system to apply the first particular DVE to at least part of the particular temporal portion of the video segment, thereby causing second content to be overlaid within the region of at least part of the particular temporal portion.

### USAGE AND TERMINOLOGY

Throughout this application, with respect to all reasonable derivatives of such terms, and unless otherwise specified (and/or unless the particular context clearly dictates otherwise), each usage of “a” or “an” means at least one, and each usage of “the” means the at least one.

### BACKGROUND

Unless otherwise indicated herein, the materials described in this section are not prior art to the claims in this disclosure and are not admitted to be prior art by inclusion in this section.

A video-broadcast system may be configured to generate and broadcast a video stream to a set of receivers (e.g., set-top boxes) for viewing by end-users. The system may include multiple components for generating the video stream. For example, the system may include a digital video-effect (DVE) system, which may apply a DVE to a video segment represented by a video stream. This may result in the DVE system modifying the video segment and generating a new video stream that represents the modified video segment.

### SUMMARY

In a first aspect, an example method for use in a video-broadcast system having a DVE system is disclosed. The method includes: (i) receiving an instruction to apply a first particular DVE of a particular overlay-DVE type to a temporal portion of a video segment based, at least in part, on the temporal portion of the video segment being suitable for having a DVE of the particular overlay-DVE type applied thereto, wherein the first particular DVE corresponds to a duration; (ii) making a determination that no temporal portion of the video segment satisfies each condition in a condition set, wherein the condition set comprises (a) a first condition that the temporal portion of the video segment has been identified as being suitable for having a DVE of the particular overlay-DVE type applied thereto, and (b) a second condition that the temporal portion of the video segment is of at least the duration; and (iii) based, at least in part, on the received instruction and the determination, transmitting to the DVE system (a) a first instruction that causes the DVE system to apply a second particular DVE to a particular temporal portion of the video segment, thereby causing first content within a region of the particular temporal portion of the video segment to be removed from the region, and (b) a second instruction that causes the DVE system to apply the first particular DVE to at least part of the particular temporal portion of the video segment, thereby causing second content to be overlaid within the region of at least part of the particular temporal portion.

In a second aspect, a non-transitory computer-readable medium has stored thereon program instructions that when executed cause performance of a set of acts including: (i) receiving an instruction to apply a first particular DVE of a particular overlay-DVE type to a temporal portion of a video segment based, at least in part, on the temporal portion of the video segment being suitable for having a DVE of the particular overlay-DVE type applied thereto, wherein the first particular DVE corresponds to a duration; (ii) making a determination that no temporal portion of the video segment satisfies each condition in a condition set, wherein the condition set comprises (a) a first condition that the temporal portion of the video segment has been identified as being suitable for having a DVE of the particular overlay-DVE type applied thereto, and (b) a second condition that the temporal portion of the video segment is of at least the duration; and (iii) based, at least in part, on the received instruction and the determination, transmitting to a DVE system (a) a first instruction that causes the DVE system to apply a second particular DVE to a particular temporal portion of the video segment, thereby causing first content within a region of the particular temporal portion of the video segment to be removed from the region, and (b) a second instruction that causes the DVE system to apply the first particular DVE to at least part of the particular temporal portion of the video segment, thereby causing second content to be overlaid within the region of at least part of the particular temporal portion.

In a third aspect, a video-broadcast system includes an automation system; a communication network; and a DVE system connected to the automation system via the communication network, wherein the automation system is configured for performing a set of acts including: (i) receiving an instruction to apply a first particular DVE of a particular overlay-DVE type to a temporal portion of a video segment based, at least in part, on the temporal portion of the video segment being suitable for having a DVE of the particular overlay-DVE type applied thereto, wherein the first particular DVE corresponds to a duration; (ii) making a determination that no temporal portion of the video segment satisfies each condition in a condition set, wherein the condition set comprises (a) a first condition that the temporal portion of the video segment has been identified as being suitable for having a DVE of the particular overlay-DVE type applied thereto, and (b) a second condition that the temporal portion of the video segment is of at least the duration; and (iii) based, at least in part, on the received instruction and the determination, transmitting to the DVE system via the communication network (a) a first instruction that causes the DVE system to apply a second particular DVE to a particular temporal portion of the video segment, thereby causing first content within a region of the particular temporal portion of the video segment to be removed from the region, and (b) a second instruction that causes the DVE system to apply the first particular DVE to at least part of the particular temporal portion of the video segment, thereby causing second content to be overlaid within the region of at least part of the particular temporal portion.

### BRIEF DESCRIPTION OF THE DRAWINGS

FIG. 1 is a simplified block diagram illustrating an example system.

FIG. 2 is a simplified block diagram illustrating an example computing device.

FIG. 3 is a flow chart illustrating an example method.

FIG. 4 is a simplified diagram illustrating a timeline representation of an example video segment.

FIG. 5 is a simplified diagram illustrating a timeline representation of multiple video frames of an example video segment.

### DETAILED DESCRIPTION

### I. Overview

The following detailed description describes various features, acts and/or functions of the disclosed systems and methods with reference to the accompanying figures. In the figures, similar symbols identify similar components, unless context dictates otherwise. The illustrative system and method embodiments described herein are not meant to be limiting. It may be readily understood that certain aspects of the disclosed systems and methods can be arranged and combined in a wide variety of different configurations, all of which are contemplated herein.

As indicated above, a DVE system may apply a DVE to a video segment. There are various types of overlay-DVEs, one example of which is a ticker DVE. A ticker DVE is a DVE in which content (e.g., in the form of text, image, and/or video content) is overlaid on a region of video content and displayed in a scrolling manner. There are also various types of ticker DVEs. For instance, in connection with one type of ticker DVE, an urgent message pertaining to local weather may be overlaid, in a scrolling manner, on a bottom region of video content. In this instance, the message may be scrolled from right to left in order to assist a viewer in reading the message. In another instance, in connection with another type of ticker DVE, descriptions of upcoming segments of a show may be overlaid on a left-side region of video content. The descriptions of upcoming segments may be scrolled in a vertical manner as the show progresses through the upcoming segments.

In some instances, an applied ticker DVE may cause an undesirable experience for a viewer. For instance, where a video segment includes text (e.g., opening credits of a show) in a bottom region, and where a ticker DVE is of the type where an urgent message is overlaid on the bottom region, applying the ticker DVE to a temporal portion of the video segment may result in the urgent message and the text becoming jumbled, which may be distracting to a viewer. The present disclosure provides a way to help facilitate the application of a ticker DVE while reducing that chance of causing an undesirable experience for a viewer.

According to the present disclosure, an example method includes an automation system receiving an instruction to apply a first particular DVE of a particular overlay-DVE type to a temporal portion of a video segment, based, at least in part, on the temporal portion of the video segment being suitable for having a DVE of the particular overlay-DVE type applied thereto, wherein the first particular DVE corresponds to a duration. In one example, the act of receiving the instruction may include receiving a portion of a traffic schedule associated with a video-broadcast system, and extracting the instruction from the received portion of the traffic schedule.

Further, the method may include the automation system making a determination that no particular temporal portion of the video segment satisfies each condition in a condition set. The condition set may include a first condition that the temporal portion of the video segment has been identified as being suitable for having a DVE of the particular overlay-DVE type applied thereto and a second condition that the temporal portion of the video segment is of at least the duration.

Still further, the method may include, based, at least in part, on the received instruction and the determination, the automation system transmitting to the DVE system a first instruction that causes the DVE system to apply a second particular DVE to a particular temporal portion of the video segment, thereby causing first content within a region of the particular temporal portion of the video segment to be removed from the region. The method may also include, based, at least in part, on the received instruction and the determination, the automation system transmitting to the DVE system a second instruction that causes the DVE system to apply the first particular DVE to at least part of the particular temporal portion of the video segment, thereby causing second content to be overlaid within the region of at least part of the particular temporal portion. This may result in the automation system applying the particular DVE to a modified suitable temporal-portion (and not to an unsuitable temporal-portion) of the video segment, thereby reducing the chance of the viewer having an undesirable experience.

### II. Example System

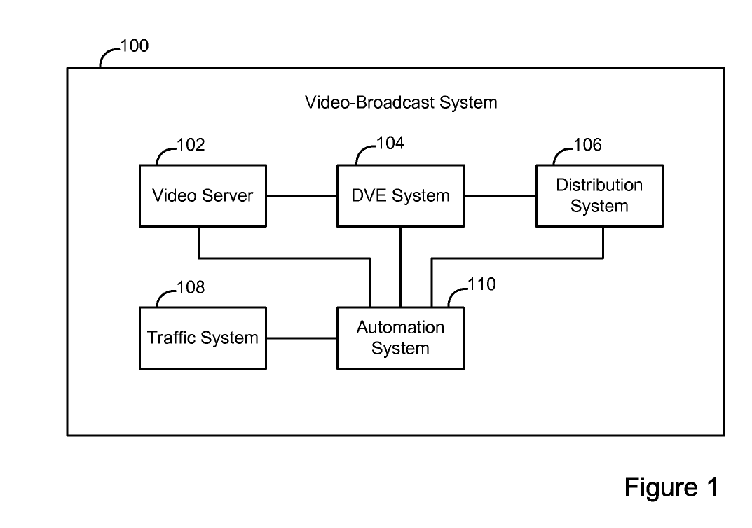

FIG. 1 is a simplified block diagram illustrating an example video-broadcast system 100. The video-broadcast system 100 may take a variety of forms, such as that of a television-broadcast system. The video-broadcast system 100 may include a video server 102, a DVE system 104, a distribution system 106, a traffic system 108, and an automation system 110.

The systems and devices of the video-broadcast system 100 may be connected in various ways. For example, the DVE system 104 may be connected to the video server 102 and the distribution system 106. And the automation system 110 may be connected to the video server 102, the DVE system 104, the distribution system 106, and the traffic system 108.

Each connection described in this disclosure may be a direct connection or an indirect connection, the latter being a connection that passes through or traverses one or more devices, such as a router, switcher, or other network device.

The video server 102 may be configured to load a video asset. This may involve the video server 102 retrieving from a data storage unit a file representing the video asset. The video server 102 may also be configured to playout the video asset. This may involve the video server 102 converting a retrieved file into a video stream and outputting the video stream. In one example, the video server 102 may transmit the video stream to the DVE system 104.

The DVE system 104 may be configured to perform various functions related to DVEs. For example, the DVE system 104 may be configured to receive a video stream representing a video segment and apply a DVE to the video segment. This may result in the DVE system 104 modifying the video segment and generating a new video stream that represents the modified video segment. The DVE system 104 may further be configured for outputting the generated video stream. In one example, the DVE system 104 may transmit the generated video stream to the distribution system 106.

The DVE system 104 may take various forms, such as that of a stunt switcher. An example of a stunt switcher is the Miranda NVISION NVS5100MC provided by NVision, Inc. of Coppell, Tex.

There are various types of overlay-DVEs, one example of which is a ticker DVE. A ticker DVE is a DVE in which content (e.g., in the form of text, image, and/or video content) is overlaid on a region of video content and displayed in a scrolling manner. There are also various types of ticker DVEs. For instance, in connection with one type of ticker DVE, an urgent message pertaining to local weather may be overlaid, in a scrolling manner, on a bottom region of video content. In this instance, the message may be scrolled from right to left in order to assist a viewer in reading the message. In another instance, in connection with another type of ticker DVE, descriptions of upcoming segments of a show may be overlaid on a left-side region of video content. The descriptions of upcoming segments may be scrolled in a vertical manner as the show progresses through the upcoming segments.

Another type of DVE is a pull-back DVE. A pull-back DVE is a DVE in which at least a portion of content is reduced in size (creating the effect of the content being “pulled back”). This also results in at least a portion of content within a given region of the video segment being removed from the region. Removing content from a region may allow additional content to be overlaid within the region. In one instance, a first instruction may cause the DVE system 104 to apply a pull-back DVE to a particular temporal portion of a video segment that thereby causes content within a bottom region to be removed from the bottom region. Then, a second instruction may cause the DVE system 104 to apply a ticker DVE to the particular temporal portion of the video segment and thereby cause second content, such as an urgent message pertaining to local weather, to be overlaid within the region of at least part of the particular temporal portion.

The DVE system 104 may also be configured to assist a user in designing a DVE. For example, a user may design an overlay DVE by specifying what the overlaying content should be, and where on video content should the overlaying content be overlaid. While or after a DVE is designed, the DVE system 104 may generate and store a corresponding set of instructions into a data storage unit.

To apply the DVE to video content, the DVE system 104 may then retrieve and execute the corresponding set of instructions. In one example, this may cause the DVE system 104 to use one or more layers known as “keys” to modify the video content such that the DVE system 104 can generate a video stream representing the modified video content.

In some instances, an overlay DVE may have a specified duration. In such cases, the DVE system 104 may automatically stop applying the overlay DVE after the specified duration has lapsed.

Another example type of DVE is a removal DVE. A removal DVE may be configured to remove an overlay DVE from video content. In one example, the removal DVE may simply “reset” all keys such that no overlaying content or other effects remain, thereby ensuring that any overlay DVE is removed from the video content. In some instances, an overlay DVE may not have a specified duration. In such cases, the DVE system 104 may apply a removal DVE at a desired time to stop the overlay DVE from being applied.

In some instances, the DVE system 104 may also store in a data storage unit content intended to be used in connection with an overlay DVE (e.g., a channel or station logo). In other instances, the DVE system 104 may receive such content (e.g., from the video server 102) as the DVE is being applied.

As used throughout this disclosure, the term broadcast means the distribution of media (e.g., audio, video, or a combination thereof) via any means. As such, the distribution system 106 may be configured to distribute a video stream to an end-user device via any means for presentation to an end-user. In practice, the distribution system 106 may distribute a video stream to a mass number of end-user devices for presentation to a mass number of end-users. The distribution system 106 may include various systems or components, such as a terrestrial antenna or a satellite, and may be configured for distributing the video stream to the end-user device in a variety of ways. For example, the distribution system 106 may distribute the video stream over-the-air or via a packet-based network such as the Internet. The end-user device may take a variety of forms, such as that of a television, a television set-top box, or a computing device. The traffic system 108 may be configured to perform operations related to broadcast scheduling. For example, the traffic system 108 may be configured to facilitate the creation and modification of a traffic schedule, and to output the traffic schedule. A traffic schedule is a schedule of broadcast-related events, typically for a particular channel or station. A traffic schedule is sometimes referred to in the broadcast industry as a traffic log. An example of the traffic system 108 is Wide Orbit Traffic provided by Wide Orbit Inc. of San Francisco, Calif. In one example, the traffic system 108 may transmit a traffic schedule to the automation system 110.

The automation system 110 may be configured to perform operations related to broadcast scheduling and sequencing. For example, the automation system 110 may be configured to receive a traffic schedule from the traffic system 108, and to modify the traffic schedule, such as by adding information to it. For example, where a record of the traffic schedule indicates that a particular video segment has been scheduled, the automation system 110 may add to that record an indication of a particular video server assigned to load and playout that video segment. In practice, the automation system 110 may modify multiple records of the traffic schedule in this manner. A traffic schedule that has been modified with this additional information is sometimes referred to in the broadcast industry as a playlist.

The automation system 110 may also be configured to control one or more systems or devices. In one example, the automation system 110 may traverse records of a traffic schedule, and control systems or devices based on the entries in those traversed records. The automation system 110 may control a system or device in various ways, such as by transmitting a suitable instruction to the system or device.

In one example, the automation system 110 may be configured to control one or more systems or devices of the video-broadcast system 100, such as the DVE system 104. By way of example, the automation system 110 may transmit to the DVE system 104 one or more instructions, such as those described above.

In some examples, the video-broadcast system 100 may be integrated with an audio-broadcast system, such that a video stream representing video content may be broadcast together with an audio stream representing corresponding audio content. In some instances, the video stream and the audio stream may be combined into a single media stream.

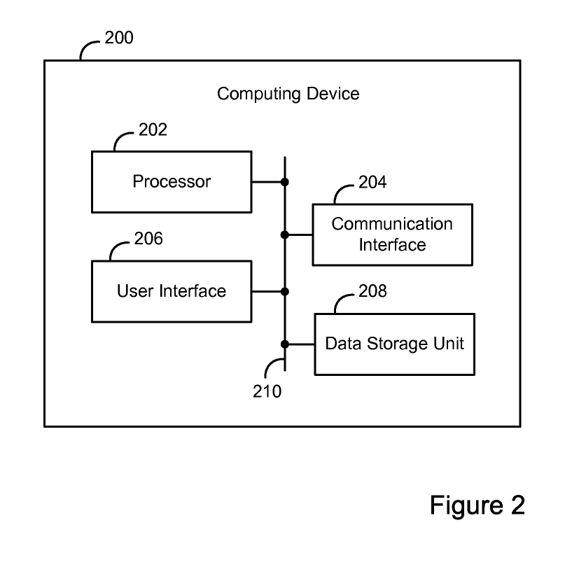

FIG. 2 is a simplified block diagram illustrating an example computing device 200. The device 200 may be configured for performing a variety of functions or acts, such as those described in this disclosure (including the accompanying drawings). The device 200 may include various components, including for example, a processor 202, a communication interface 204, a user interface 206, and a data storage unit 208. The components of the device 200 may be communicatively connected to each other (or other devices or systems) via a system bus, network, or other connection mechanism 210.

The processor 202 may include a general purpose processor (e.g., a microprocessor) and/or a special purpose processor (e.g., a digital signal processor (DSP)).

The communication interface 204 may be configured to allow the device 200 to communicate with one or more devices or systems according to one or more protocols. In one example, the communication interface 204 may be a wired interface, such as an Ethernet interface or a high-definition serial-digital-interface (HD-SDI). As another example, the communication interface 204 may be a wireless interface, such as a cellular or WI-FI interface.

The user interface 206 may facilitate interaction with a user of the device, if applicable. As such, the user interface 206 may include input components such as a keyboard, a keypad, a mouse, a touch-sensitive panel, a microphone, and a camera, and output components such as a display screen (which, for example, may be combined with a touch-sensitive panel), a sound speaker, and a haptic feedback system. In one example, the device 200 may receive, via the user interface 206, input that may be used to design a DVE.

The data storage unit 208 may include one or more volatile, non-volatile, removable, and/or non-removable storage components, such as magnetic, optical, or flash storage, and may be integrated in whole or in part with the processor 202. Further, the data storage unit 208 may take the form of a non-transitory computer-readable storage medium, having stored thereon program instructions (e.g., compiled or non-compiled program logic and/or machine code) that, when executed by the processor 202, cause the device 200 to perform one or more functions or acts, such as those described in this disclosure. Such program instructions may define or be part of a discrete software application that can be executed in response to certain input received via user interface 206, for instance. The data storage unit 208 may also store other types of information or data, such as those types described throughout this disclosure.

### III. Example Operations

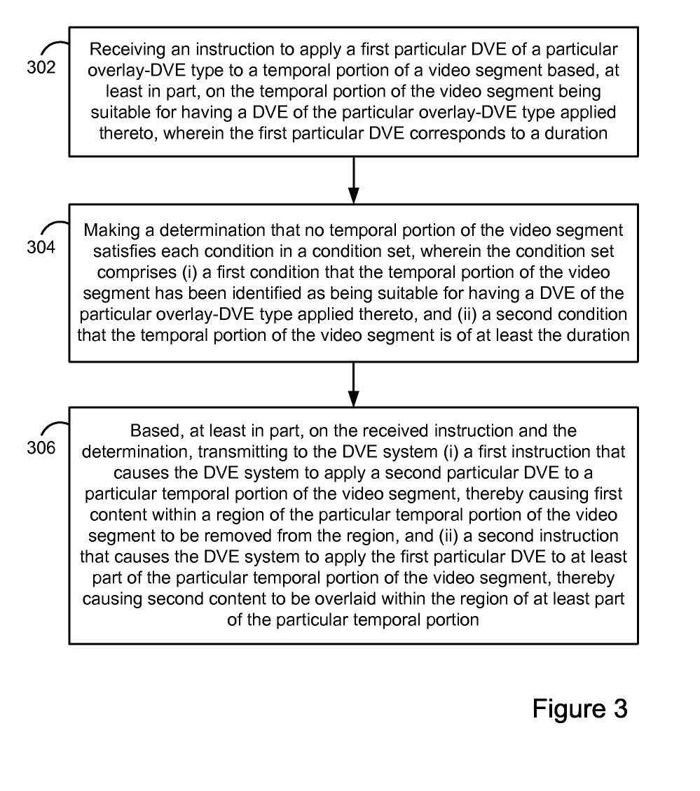

FIG. 3 is a flow chart illustrating an example method 300. The method 300 may be used in connection with a system including an automation system, a communication network, and a DVE system. In one example, the method 300 may be used in connection with the system 100.

At block 302, the method may include receiving an instruction to apply a first particular DVE of a particular overlay-DVE type to a temporal portion of a video segment based, at least in part, on the temporal portion of the video segment being suitable for having a DVE of the particular overlay-DVE type applied thereto, wherein the first particular DVE corresponds to a duration. For instance, the method may include the automation system 110 receiving such an instruction. In one example, this may include the automation system 110 receiving a portion of a traffic schedule from the traffic system 108, and extracting the instruction from the received portion of the traffic schedule.

The DVE of the particular overlay-DVE type may refer to a DVE where a particular type of content is overlaid and/or where content is overlaid on a particular region of video content. As such, in one example, the DVE of the particular overlay-DVE type may refer to a particular ticker DVE where content is overlaid on a bottom region of video content.

In some examples, the received instruction may provide additional details relating to the manner in which the particular DVE should be applied to a suitable temporal portion of the video segment. For example, the instruction may be an instruction to apply the particular ticker DVE to a particular region of the temporal portion of the video segment. As another example, the instruction may be an instruction to apply the particular ticker DVE to one or more temporal portions of the video segment.

At block 304, the method may include making a determination that no temporal portion of the video segment satisfies each condition in a condition set, wherein the condition set includes (i) a first condition that the temporal portion of the video segment has been identified as being suitable for having a DVE of the particular overlay-DVE type applied thereto, and (ii) a second condition that the temporal portion of the video segment is of at least the duration (e.g., 30 seconds). For instance, this may involve the automation system 110 making such a determination.

In one scenario, via a user interface of a computing device, a user may watch or scan through a video segment, and mark one or more temporal portions of the video segment that the user identifies as being suitable for having a DVE of the particular overlay-DVE type applied thereto. The user may identify such temporal portions based on the temporal portions of the video segment having a particular characteristic. For example, the user may identify such temporal portions based on a bottom region of the temporal portions of the video segment lacking text or other content that may interfere with content that may be overlaid thereon. In another scenario, the computing device may employ a suitable algorithm to automatically detect and mark one or more temporal portions of the video segment that are suitable for having a DVE of the particular overlay-DVE type applied thereto, again perhaps based on the temporal portions of the video segment having a particular characteristic.

In either scenario, the computing device may then store data representing these markings, perhaps as video segment metadata, and the automation system 110 may retrieve and use this data to make the first determination that the particular temporal portion of the video segment has been identified as being suitable for having a DVE of the particular overlay-DVE type applied thereto.

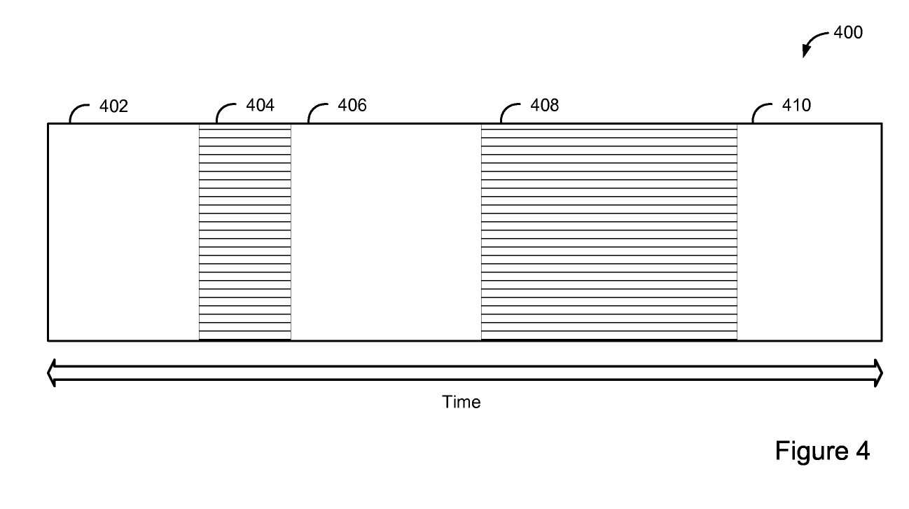

To help illustrate the concept, consider FIG. 4, which is a simplified diagram illustrating a timeline representation of an example video segment 400. The video segment 400 may include one or more temporal portions 402, 406, and 410 that are unsuitable for having a DVE of a particular overlay-DVE type applied thereto. The video segment 400 may also include temporal portions 404 and 408 that are suitable for having a DVE of the particular overlay-DVE type applied thereto, and which have been identified as such.

In some examples, the condition set may include additional conditions. For instance, the condition set may also include a third condition that a start time of the temporal portion of the video segment is within a period of time associated with the received instruction. In one example, the third condition may be useful when there is a desire to apply a DVE to overlay breaking news.

At block 306, the method may include based, at least in part, on the received instruction and the determination, transmitting to the DVE system (i) a first instruction that causes the DVE system to apply a second particular DVE to a particular temporal portion of the video segment, thereby causing first content within a region of the particular temporal portion of the video segment to be removed from the region, and (ii) a second instruction that causes the DVE system to apply the first particular DVE to at least part of the particular temporal portion of the video segment, thereby causing second content to be overlaid within the region of at least part of the particular temporal portion. For instance, this may involve, based, at least in part, on the received instruction and the determination, the automation system 110 transmitting such an instruction to the DVE system 104. As a result, the DVE system 104 may apply the first and second particular DVEs as described above.

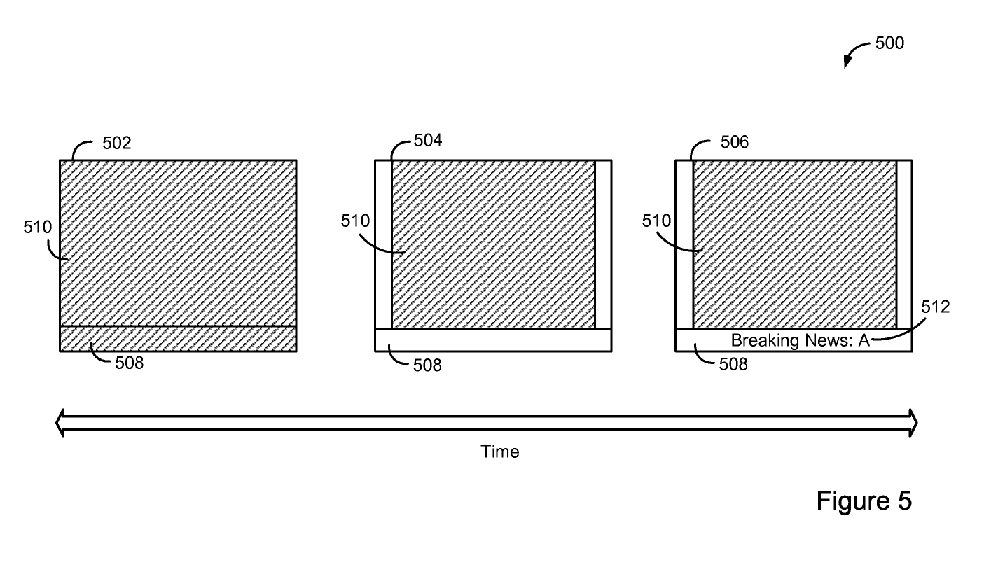

To help illustrate the concept, consider FIG. 5, which is a simplified diagram illustrating a timeline representation of multiple video frames of an example video segment 500. The video segment 500 may include video frames 502, 504, and 506. The video segment 500 (and therefore each video frame 502, 504, and 506) may include various regions of content, such as a region 508.

As shown, video frame 502 may include first content 510 that does not allow for a particular ticker DVE to be overlaid in the region 508 without causing a distraction to a viewer. In order to prevent the distraction, the automation system 110 may transmit a first instruction to the DVE system 104 to apply a particular pull-back DVE that causes at least part of first content 508 to be removed from region 510, as shown in video frame 504. In some example, the DVE system 104 may apply another particular type of DVE that results in at least part of the content 508 being removed from the region 510. For example, the DVE system 104 may apply a particular DVE that shifts the content 510 up, thereby removing at least a part of the content 510 from the region 508.

Further, the automation system 110 may transmit a second instruction that causes the DVE system 104 to apply a particular ticker DVE, thereby causing second content 512 to be overlaid within the region 510, as shown in video frame 506. By way of example, the video segment 500 may include one or more additional video frames between video frames 502, 504, and 506.

Referring back to the act at block 304, in one scenario, the determination may be a first determination and the method may further include making a second determination that the second content has a particular property. The particular property may be used to prioritize a DVE in in order to apply the DVE in a quick manner. For instance, the particular property may be that the DVE is configured to overlay certain types of information (e.g., a hazardous weather warning).

Depending on the nature of the received instruction, the automation system 110 may perform additional acts and/or the act at block 304 may vary, as appropriate. For example, where the automation system 110 makes the first and second determinations, the act at block 306 may include based, at least in part, on the received instruction, the first determination, and the second determination, transmitting to the DVE system the first and second instructions.

### IV. Example Variations

While one or more acts have been described as being performed by certain devices, systems, or entities (e.g., the computing device 200), the acts may be performed by any device, system, or entity, such as those described in connection with the video-broadcast system 100. For example, in some instances, the described acts may be performed by a television, set-top box, or other device, system or entity at the viewer's end, rather than by one or more components of a video-broadcast system. Furthermore, the devices and systems need not be discrete entities. Some or all of the devices or systems may be combined into a single device or system, or otherwise arranged.

In addition, the acts described herein need not be performed in the disclosed order, although in some examples an order may be preferred. Also, not all acts need to be performed to achieve the desired advantages of the disclosed systems, devices, and methods, and therefore not all acts are required. Variations discussed in connection with one example may be applied to all other examples disclosed herein.

While select examples of the present disclosure have been described, alterations and permutations of these examples will be apparent to those of ordinary skill in the art. Other changes, substitutions, and alterations are also possible without departing from the broader aspects of the invention as set forth in the following claims.

1. A method for use in a video-broadcast system having a digital video-effect (DVE) system, the method comprising:
receiving an instruction to apply a first particular DVE of a particular overlay-DVE type to a temporal portion of a video segment based, at least in part, on the temporal portion of the video segment being suitable for having a DVE of the particular overlay-DVE type applied thereto, wherein the first particular DVE corresponds to a duration;
making a determination that no temporal portion of the video segment satisfies each condition in a condition set, wherein the condition set comprises (i) a first condition that the temporal portion of the video segment has been identified as being suitable for having a DVE of the particular overlay-DVE type applied thereto, and (ii) a second condition that the temporal portion of the video segment is of at least the duration; and
based, at least in part, on the received instruction and the determination, transmitting to the DVE system (i) a first instruction that causes the DVE system to apply a second particular DVE to a particular temporal portion of the video segment, thereby causing first content within a region of the particular temporal portion of the video segment to be removed from the region, and (ii) a second instruction that causes the DVE system to apply the first particular DVE to at least part of the particular temporal portion of the video segment, thereby causing second content to be overlaid within the region of at least part of the particular temporal portion.

2. The method of claim 1, wherein receiving the instruction comprises (i) receiving a portion of a traffic schedule and (ii) extracting the instruction from the received portion of the traffic schedule.

3. The method of claim 1, wherein the first particular DVE comprises a particular ticker DVE.

4. The method of claim 1, wherein the condition set further comprises a third condition that a start time of the temporal portion of the video is within a period of time associated with the received instruction.

5. The method of claim 1, wherein the determination is a first determination, the method further comprising:
making a second determination that the second content has a particular property, wherein based, at least in part, on the received instruction and the first determination comprises based, at least in part, on the received instruction, the first determination, and the second determination.

6. The method of claim 1, wherein the DVE system comprises a stunt switcher.

7. The method of claim 1, wherein the second particular DVE comprises a particular pull-back DVE.

8. A non-transitory computer-readable medium having stored thereon program instructions that when executed cause performance of a set of acts comprising:
receiving an instruction to apply a first particular DVE of a particular overlay-DVE type to a temporal portion of a video segment based, at least in part, on the temporal portion of the video segment being suitable for having a DVE of the particular overlay-DVE type applied thereto, wherein the first particular DVE corresponds to a duration;
making a determination that no temporal portion of the video segment satisfies each condition in a condition set, wherein the condition set comprises (i) a first condition that the temporal portion of the video segment has been identified as being suitable for having a DVE of the particular overlay-DVE type applied thereto, and (ii) a second condition that the temporal portion of the video segment is of at least the duration; and
based, at least in part, on the received instruction and the determination, transmitting to a DVE system (i) a first instruction that causes the DVE system to apply a second particular DVE to a particular temporal portion of the video segment, thereby causing first content within a region of the particular temporal portion of the video segment to be removed from the region, and (ii) a second instruction that causes the DVE system to apply the first particular DVE to at least part of the particular temporal portion of the video segment, thereby causing second content to be overlaid within the region of at least part of the particular temporal portion.

9. The non-transitory computer-readable medium of claim 8, wherein receiving the instruction comprises (i) receiving a portion of a traffic schedule and (ii) extracting the instruction from the received portion of the traffic schedule.

10. The non-transitory computer-readable medium of claim 8, wherein the first particular DVE comprises a particular ticker DVE.

11. The non-transitory computer-readable medium of claim 8, wherein the condition set further comprises a third condition that a start time of the temporal portion of the video is within a period of time associated with the received instruction.

12. The non-transitory computer-readable medium of claim 8, wherein the determination is a first determination, the set of acts further comprising:
making a second determination that the second content has a particular property, wherein based, at least in part, on the received instruction and the first determination comprises based, at least in part, on the received instruction, the first determination, and the second determination.

13. The non-transitory computer-readable medium of claim 8, wherein the DVE system comprises a stunt switcher.

14. The non-transitory computer-readable medium of claim 8, wherein the second particular DVE comprises a particular pull-back DVE.

15. A video-broadcast system comprising:
an automation system;
a communication network; and
a digital video-effect (DVE) system connected to the automation system via the communication network, wherein the automation system is configured for performing a set of acts comprising:
receiving an instruction to apply a first particular DVE of a particular overlay-DVE type to a temporal portion of a video segment based, at least in part, on the temporal portion of the video segment being suitable for having a DVE of the particular overlay-DVE type applied thereto, wherein the first particular DVE corresponds to a duration;
making a determination that no temporal portion of the video segment satisfies each condition in a condition set, wherein the condition set comprises (i) a first condition that the temporal portion of the video segment has been identified as being suitable for having a DVE of the particular overlay-DVE type applied thereto, and (ii) a second condition that the temporal portion of the video segment is of at least the duration; and
based, at least in part, on the received instruction and the determination, transmitting to the DVE system via the communication network (i) a first instruction that causes the DVE system to apply a second particular DVE to a particular temporal portion of the video segment, thereby causing first content within a region of the particular temporal portion of the video segment to be removed from the region, and (ii) a second instruction that causes the DVE system to apply the first particular DVE to at least part of the particular temporal portion of the video segment, thereby causing second content to be overlaid within the region of at least part of the particular temporal portion.

16. The video-broadcast system of claim 15, wherein receiving the instruction comprises (i) receiving a portion of a traffic schedule and (ii) extracting the instruction from the received portion of the traffic schedule.

17. The video-broadcast system of claim 15, wherein the first particular DVE comprises a particular ticker DVE.

18. The video-broadcast system of claim 15, wherein the determination is a first determination, the set of acts further comprising:
making a second determination that the second content has a particular property, wherein based, at least in part, on the received instruction and the first determination comprises based, at least in part, on the received instruction, the first determination, and the second determination.

19. The video-broadcast system of claim 15, wherein the DVE system comprises a stunt switcher.

20. The video-broadcast system of claim 15, wherein the second particular DVE comprises a particular pull-back DVE.
